(19) United States
(12) Patent Application Publication
(10) Pub. No.: US 2026/0362221 A1
(43) Pub. Date: Nov. 12, 2026

(54) L4S ACTIVE QUEUE MANAGEMENT LOAD SHEDDING FOR ACCESS POINTS

(71) Applicant: Cisco Technology, Inc., San Jose, CA (US)

(72) Inventors: Robert Edgar Barton, Richmond (CA); Jerome Henry, Pittsboro, NC (US); Juan Carlos Zuniga, Montreal (CA); Binita Gupta, San Diego, CA (US)

(21) Appl. No.: 19/262,452

(22) Filed: Jul. 8, 2025

Related U.S. Application Data
(60) Provisional application No. 63/800,526, filed on May 6, 2025.

(51) Int. Cl. H04W 28/02; H04W 48/20; H04W 84/12

(52) U.S. Cl. CPC H04W 28/0268; H04W 28/0284; H04W 48/20; H04W 84/12

(57) ABSTRACT

Techniques for addressing enhanced Low Latency, Low Loss, Scalable Throughput (L4S) congestion on an Access Point (AP) by load shedding stations (STAs) to nearby APs which have better congestion conditions. In one embodiment, an AP may select the most likely candidate APs to which to push a STA to roam to using the IEEE 802.11v Basic Service Set (BSS) Transition Management (BTM) mechanism. In another embodiment, a STA initiates a process to roam from a first AP that is currently serving the STA to another AP of a plurality of other neighboring APs that has better L4S congestion conditions for the STA.

### CROSS-REFERENCE TO RELATED APPLICATION

This application claims priority to U.S. Provisional Patent Application No. 63/800,526, filed May 6, 2025, the entirety of which is incorporated herein by reference.

### TECHNICAL FIELD

The present disclosure relates to wireless network equipment and services.

### Background

Networking architectures have grown increasingly complex in communications environments, particularly wireless networking environments. For wireless local area networks (WLANs), Institute of Electrical and Electronics Engineers (IEEE) 802.11 specifications are working towards the definition of Low Latency, Low Loss, Scalable Throughput (L4S) mechanisms for implementation via WLAN access points (APs) and client devices or stations (STAs). Thus, there are new challenges and opportunities with regard to L4S solutions that can be provided for WLAN APs and STAs.

### BRIEF DESCRIPTION OF THE DRAWINGS

FIG. 1A is a diagram of a wireless local area network (WLAN) that includes STAs and APs that support L4S congestion mechanisms, and in which a serving AP is configured to shed a STA based on L4S congestion metrics, according to an example embodiment.

FIG. 1B is a diagram illustrating example details indicating how a Low Latency, Low Loss, Scalable Throughput (L4S) queue may be implemented at the IEEE 802.11 Media Access Control (MAC) layer, according to an example embodiment.

FIG. 2 is a diagram of a Basis Service Set (BSS) Transition Management (BTM) Request message that includes information configured to cause a STA to roam to a specified neighboring wireless AP based on L4S congestion metrics experienced by a serving AP, according to an example embodiment.

FIG. 3 is a diagram of a WLAN that includes STAs and APs that support L4S congestion mechanisms, and in which a STA is configured to request information about L4S congestion metrics of neighboring APs of a serving AP in order to select a target neighboring AP to which to roam for better L4S performance, according to an example embodiment.

FIG. 4A is a diagram depicting a BTM Query message that a STA sends to its serving AP to request information about L4S congestion metrics of neighboring APs of a serving AP in order to select a target neighboring AP to which to roam for better L4S performance, according to an example embodiment.

FIG. 4B is a diagram of a Neighbor Report Element that may be included in a BTM Request message that a serving AP sends, in response to the BTM Query message of FIG. 4A, to provide information about L4S congestion metrics of neighboring APs of a serving AP to allow a STA to select a target neighboring AP to which to roam for better L4S performance, according to an example embodiment.

FIG. 5 is a flow chart depicting operations performed by a serving AP in connection with the techniques depicted in FIGS. 1A and 2, according to an example embodiment.

FIG. 6 is a flow chart depicting operations performed by a STA in connection with the techniques depicted in FIGS. 3, 4A and 4B, according to an example embodiment.

FIG. 7 illustrates a hardware block diagram of a computing device configured to perform functions associated with operations discussed in connection with embodiments herein.

### DETAILED DESCRIPTION

### Overview

Embodiments presented herein provide techniques for addressing enhanced Low Latency, Low Loss, Scalable Throughput (L4S) congestion on an Access Point (AP) by load shedding stations (STAs) to nearby APs which have better congestion conditions. In one embodiment, an AP may select the most likely candidate APs to which to push a STA to roam to using the IEEE 802.11v Basic Service Set (BSS) Transition Management (BTM) mechanism. In another embodiment, a STA initiates a process to roam from a serving AP to a neighboring AP of a plurality of neighboring APs that has better L4S congestion conditions for the STA.

In one embodiment, a method is provided that includes steps of: obtaining, by a first wireless AP in a wireless local area network, from one or more neighboring wireless APs to the first wireless AP, low latency traffic congestion metrics for low latency traffic and non-low latency congestion metrics for non-low latency traffic served by the one or more neighboring wireless APs and a count of wireless stations served by the one or more neighboring wireless APs for low latency traffic and for non-low latency traffic, wherein the low latency traffic is Low Latency, Low Loss, Scalable Throughput (L4S) traffic that includes packets having information in a header indicating that the packets are carrying L4S traffic based on marking of the packets; determining a candidate wireless station for which the first wireless AP is handling low latency traffic to be shed to a neighboring wireless AP of the one or more neighboring wireless APs; polling, by the first wireless AP, one or more candidate wireless APs of the one or more neighboring wireless APs, with information about a low latency queue at the first wireless AP for the candidate wireless station to be shed; receiving an acceptance response or rejection response from the one or more candidate wireless APs to accept the candidate wireless station; and selecting a target wireless AP to which the candidate wireless station is to roam.

In another embodiment, a method is provided that includes steps of: determining, by a wireless station operating in a wireless local area network, that there is congestion for low latency traffic served by a first wireless access point (AP) for the wireless station in the wireless local area network, wherein the low latency traffic is Low Latency, Low Loss, Scalable Throughput (L4S) traffic that includes packets having information in a header indicating that the packets are carrying L4S traffic based on marking of the packets; sending, by the wireless station, to the first wireless AP, a query for information about a neighboring wireless AP, among one or more neighboring wireless APs to the first wireless AP, that can serve low latency traffic with better performance than the first wireless AP, the first wireless AP having obtained, from the one or more neighboring wireless APs, low latency traffic congestion metrics for low latency traffic and non-low latency congestion metrics for non-low latency traffic served by the one or more neighboring wireless APs; receiving, from the first wireless AP, a transition request that indicates one or more candidate target neighboring wireless APs, among the one or more neighboring wireless APs, which can serve the low latency traffic of the wireless station with better performance than the first wireless AP; and roaming, by the wireless station, to a target neighboring wireless AP of the one or more candidate target neighboring wireless APs.

### Example Embodiments

In a wireless local area network (WLAN), such as an IEEE 802.11 (Wi-Fi®) network, one or more wireless APs provide wireless Radio Frequency (RF) coverage over which one or more wireless devices (e.g., phones, wearable devices, tablets, etc.), often referred to as wireless client devices or stations (STAs) can connect to the APs in order to connect to one or more data networks (e.g., the public Internet, an enterprise network operated by an enterprise entity (e.g., a business, institution, university, etc.)), and/or the like.

Low Latency, Low Loss, Scalable Throughout (L4S) is an architecture and protocol suite defined by the Internet Engineering Task Force (IETF), such as through Request for Comments (RFCs) 9330, 9331, and 9332, with the purpose to provide low queuing latency, low packet loss, and scalable throughput control useful for a variety of real-time applications (e.g., streaming video, multiplayer games, and/or other real-time applications).

L4S is an emerging technology that can be used to manage congestion for latency-sensitive applications. However, in a Wi-Fi network, congestion is not measured in the same way that wired network nodes, such as routers or switches, measure congestion. Congestion in APs typically results from a variety of radio frequency (RF) issues that evoke similar effects as wired network congestion. For example, RF issues such as excessive contention, high channel utilization, Resource Unit exhaustion, and so on, may all result in congestion-like dynamics.

One aspect of L4S is the ability to manage both the classic (also referred to as non-L4S) queue and the L4S queue in concert using the Dual-Queue (DualQ) Coupled Active Queue Management (AQM) or other similar mechanism. DualQ supports the needs of both the non-L4S and L4S queues, ensuring both types of traffic can coexist without degrading the performance of the other.

Presented herein are techniques to actively move STAs to an adjacent/neighboring AP, thus helping to manage congestion on the current AP serving a STA.

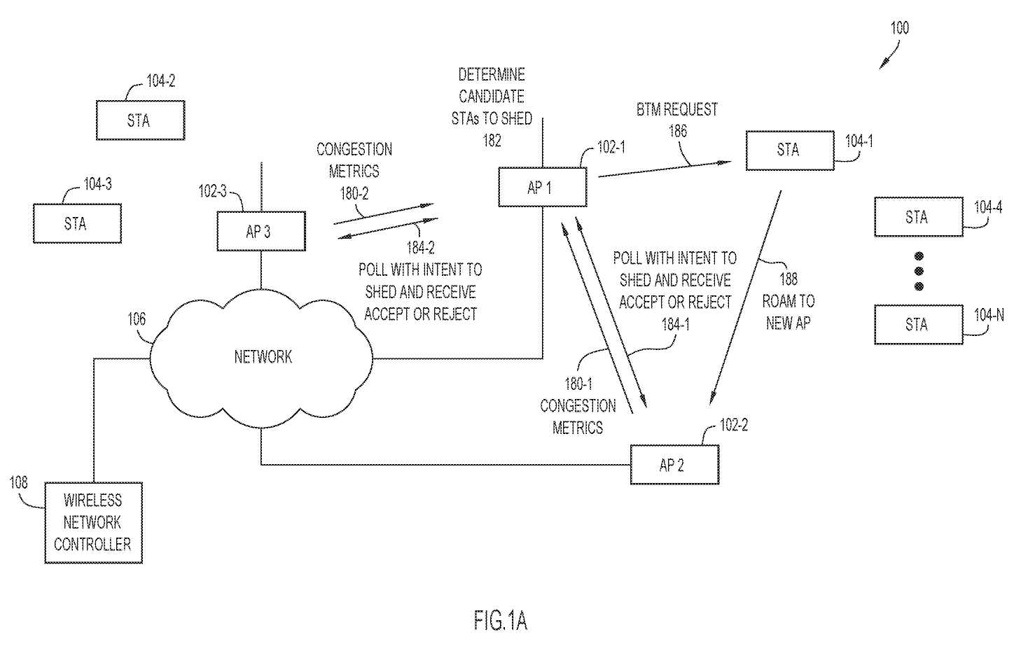

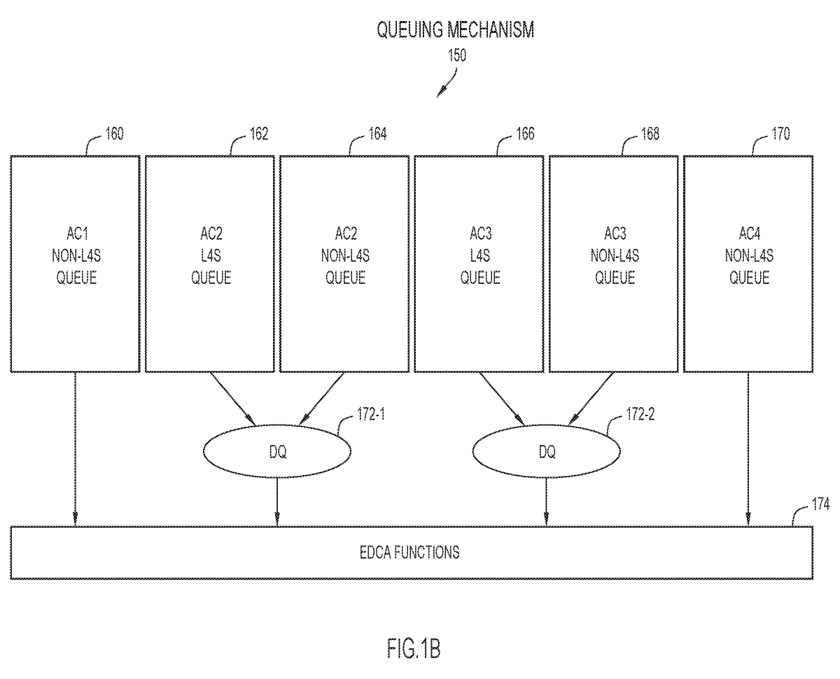

FIG. 1A illustrates a system 100 in a wireless local area network (WLAN) that includes APs and stations (STAs) that support L4S. The system 100 includes a plurality of APs, such as APs 102-1, 102-2 and 102-3, also denoted AP-1, AP-2 and AP-3, respectively. There are a plurality of STAs being served by the APs 102-1, 102-2 and 102-3. For example, there are STAs 104-1, 104-2, 104-3, 104-4, …, 104-N. It should be understood that the system 100 may include numerous more APs and STAs, and that the number and distribution of APs and STAs in FIG. 1A is by way of example. The APs 102-1, 102-2 and 102-3 may be connected to a network 106 (consisting of wired and/or wireless local area networks and wide area networks) and in turn in communication with a wireless network controller 108.

Each AP 102-1, 102-2 and 102-3 can include WLAN/802.11 hardware and/or software to perform baseband signal processing (such as modulation/demodulation) as well as hardware (e.g., baseband processors (modems), transmitters and receivers, transceivers, and/or the like), software, logic and/or the like to facilitate signal transmission and signal reception via antenna assemblies (not shown) to facilitate WLAN RF coverage (for any WLAN/802.11 variant, such as 802.11ax (Wi-Fi 6/6E), 802.11be (Wi-Fi 7), 802.11bn (Wi-Fi 8), etc.) for system 100. In at least one embodiment, wireless network controller 108 (if implemented) can facilitate communications among APs and/or control/management of APs. The wireless network controller 108 can facilitate communication with and among APs and control/manage the APs.

Each STA 104-1 to 104-N may be inclusive of any wireless device, may be considered any electronic device, that initiates a connection or communication session with a corresponding network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a cellular/WLAN enabled device, and/or any other device, component, element, or object capable of performing wireless voice, audio, video, media, or data exchanges within a system. Thus, a STA or wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes/APs of one or more radio access networks(s) including WLAN/802.11 access networks (for any WLAN/802.11 variant).

The APs 102-1, 102-2 and 102-3 may implement the L4S DualQ AQM mechanism to both mark L4S Explicit Congestion Notification (ECN) codepoints, as well as to manage the allocation of resources for both the classic and L4S queues in the presence of congestion for different Access Categories (ACs).

Unlike generic low latency queues, L4S involves a mechanism whereby if congestion is detected, then ECN marking will start either at the STA or at the AP. In other words, L4S involves a queue that is managing traffic that is L4S marked. There are flows on the Internet which may be L4S flows and there are flows which are not L4S flows (non-L4S flows). Information is included in the IP header of the packets of the traffic to indicate whether it is associated with L4S traffic or not. The L4S queue is used to manage the L4S traffic.

FIG. 1B illustrates how an L4S queue may be implemented at the 802.11 Media Access Control (MAC) layer in at least one embodiment. However, in many cases, the queues for low latency traffic (e.g., L4S traffic) and non-low latency traffic (e.g., non-L4S traffic) will likely share use of the existing ACs. An L4S queue is intended to be shallow – this is because the ECN mechanism is designed to signal between sender-receiver (client-server) that congestion is detected and to slow down the bitrate, theoretically keeping packets out of the shallow L4S queue.

FIG. 1B is a diagram illustrating example details for implementing L4S and non-L4S queues for APs 102-1, 102-2 and 102-3 of system 100. Each AP 102-1, 102-2 and 102-3 can include a corresponding queuing mechanism, such as a queuing mechanism 150 as shown in FIG. 1B.

In many cases, the L4S and non-L4S queues will likely share use of the existing ACs. For example, the queuing mechanism 150 can include a first AC non-L4S queue 160, a second AC L4S queue 162, a second AC non-L4S queue 164, a third AC L4S queue 166, a third AC non-L4S queue 168, and a fourth AC non-L4S queue 170. In some embodiments, the first AC is a background AC (AC_BK), the second AC is a best effort AC (AC_BE), the third AC is a video AC (AC_VI), and the fourth AC is a voice AC (AC_VO). The best effort AC and the video AC may include both a non-L4S (classic) queue and a L4S queue because the best effort AC and the video AC can manage a mix of L4S flows and non-L4S/classic flows. However, different ACs can have both a non-L4S queue and an L4S queue in some embodiments.

The queuing mechanism 150 may also include Distributed Queuing (DQ) switches, such as a DQ switch 172-1 and a DQ switch 172-2. The second AC L4S queue 162 and the second AC non-L4S queue 164 can both send queued traffic from the queues to DQ switch 172-1, and the third AC L4S queue 166 and the third AC non-L4S queue 168 can send the queued traffic from the queues to DQ switch 172-2. The queuing mechanism 150 also includes Enhanced Distributed Channel Access (EDCA) functions 174 for the first AC non-L4S queue 160, DQ switch 172-1, DQ switch 172-2, and the fourth AC non-L4S queue 170 to send queued traffic for subsequent transmission toward an AP or toward a STA. In at least one embodiment, the queuing mechanism 150 can be implemented at a MAC layer of a given STA or AP to enable control for L4S flow scheduling with low queuing delay and high output.

In at least one embodiment, each L4S queue can be a shallow queue and with low delay, so that each L4S queue can benefit from specific transmitting conditions. In some embodiments, frames in an L4S queue are transmitted using typical EDCA rules (e.g., according to EDCA rules for Arbitration Inter-Frame Spacing Number (AIFSN), Minimum Contention Window (CWmin), Maximum Contention Window (CWmax), retries, etc.).

As the density of L4S traffic increases on an AP, congestion can become increasingly difficult to manage. While the L4S mechanism will increase the frequency of Explicit Congestion Notification (ECN) = (Congestion Experienced) CE codepoint marking, it will also attempt to adjust the L4S and non-L4S queues. However, this becomes increasingly difficult as the WLAN becomes more congested.

One solution to this problem is for L4S congested APs to intelligently shed STAs (forcing or suggesting) or for STAs at their initiation, to roam, to other less congested nearby APs – i.e., to roam to less congested nearby APs. An example of such procedures are now described, with reference to FIGS. 1A and 1B . In the following descriptions, the serving AP is AP 102-1 and the STA that the AP 102-1 is currently serving is STA 104-1, as an example. Thus, in accordance with one aspect, the AP 102-1 may force or suggest STA 104-1 to roam to a neighboring AP, e.g., AP 102-2, and in accordance with another aspect, the STA 104-1 may determine that it should initiate a roam to another AP, e.g., AP 102-2. Again, AP 102-1 is the current serving AP for STA 104-1.

### APs Sharing Congestion Metrics

The serving AP communicates with all adjacent neighboring APs and collects congestion metrics including congestion metrics for low latency traffic (e.g., L4S) traffic as well as for non-low latency traffic. The congestion metrics may consist of performance of the non-low latency queue and performance of the low latency (L4S) queue, as well as the STA count for non-L4S traffic and L4S traffic that each neighboring AP currently serves. As shown in FIG. 1A, AP 102-1, at 180-1, obtains such congestion metrics from AP 102-2, and at 180-2, obtains congestion metrics from AP 102-3. A neighboring AP is an AP that a given AP receives wireless signals from with at least a predetermined receive signal strength threshold.

While congestion metrics can take various forms, one such possible model is a “pressure” metric that indicates the relative congestion and performance of an AP’s L4S and non-L4S queues. Any metric that reflects L4S congestion information may be used. For example, the L4S congestion metrics could be the count of incoming packets per queue/AC and time unit, ratio of received (incoming) to transmitted packets per radio and/or AC, and count of packets that were flagged ECN = CE.

To elaborate, the congestion metrics may include any combination of:
The current and/or average queue size and/or queue depth for L4S and non-L4S queues (and/or any other statistical queue metrics);
L4S Dual-Q AQM (or any other queuing mechanism/algorithm) performance parameters including, but not limited to, the L4S marking probability and queue drop probability for L4S and non-L4S queues, for both downstream and/or upstream L4S and non-L4S queues;
L4S-related queuing metrics, such as real-time delay and/or throughput performance of L4S queues; and/or
Timestamp information, which may indicate the Time Synchronization Function (TSF) time (sometimes referred to as 'time base') at which certain queue performance information is recorded.

The communication with neighboring APs can be via over-the-air (OTA) communications or wired communications. In one example, AP 102-1 may initiate the communication with APs 102-2 and 102-3 to obtain the congestion metrics from APs 102-2 and 102-3, or the APs 102-1, 102-2 and 102-3 may periodically send other congestion metrics to each. Moreover, the inter-AP communications may be performed using Multi-AP Coordination (MAPC) techniques of IEEE 802.11bn.

The serving AP, e.g., AP 102-1, may store information in the form of a table that contains the queue congestion levels of all of its neighboring APs. The AP 102-1 may store a time-series record that may be used to move STAs, if necessary.

In some embodiments, for example, if the wireless network controller 106 monitors/predicts queue information, the queue information for neighboring APs can be obtained by a given AP from (provided by) the wireless network controller 106.

The queue performance information can include, for a given neighboring AP, the current and/or average queue size/queue depth for L4S and non-L4S queues (and/or any other statistical queue metrics); L4S Dual-Q AQM (or any other queuing mechanism/algorithm) performance parameters including, but not limited to, the L4S marking probability and/or queue drop probability for L4S and/or non-L4S queues, for downstream and/or upstream L4S and non-L4S queues; L4S and/or non-L4S queue congestion prediction information; L4S-related queuing metrics, such as real-time delay and/or throughput performance of L4S queues; and/or timestamp information, which may indicate the TSF of the neighboring AP converted into the current TSF of the AP transmitting a frame containing the queue performance information. Including such timestamp information in queue performance metrics can enable an AP or STA to determine how recent or 'fresh' the queue performance information is for a given neighboring AP.

### Analyze Congestion Metrics for Associated STAs (Determine Candidate STA to Shed)

In some cases, an AP will have a high density of L4S traffic but have less traffic in the non-L4S queue. In such situations, the performance of all L4S STAs that the AP is serving will be impacted by the L4S traffic congestion. In the end, L4S performance can be affected by an increase of L4S traffic (e.g., more STAs starting L4S flows), an increase of non-L4S traffic (thus causing pressure increase on the airtime available for L4S) or an increase of interference on a given RF channel. All these elements can occur separately or in combination, possibly causing rapid spikes in the Basic Service Set (BSS) pressure (i.e., congestion in the BSS). However, if a neighboring AP is experiencing less L4S congestion, performance can be improved by moving certain STAs to the adjacent AP.

To do this, in accordance with an embodiment in which the shedding of STAs is initiated by the serving AP, then at 182, the serving AP 102-1 examines all of its associated STAs and determines which one or more STAs may be considered shedding candidates (i.e., candidate STAs which could be encouraged to roam to a neighboring AP). Generally, the shedding candidate STAs are STAs in close proximity to a neighboring AP that has better L4S resources available, in other words, a neighboring AP (e.g., AP 102-2 or AP 102-3) that can provide better low latency (L4S) traffic handling performance.

In one example, a STA in close proximity to a neighboring AP can be determined by the serving AP analyzing receive signal strength information (RSSI) and angle-of-arrival (AoA) information for receive signals from each of its neighboring APs and for receive signals from each of the STAs that it serves.

### Poll Neighboring APs with Intent to Shed and Receive Accept or Reject

In the embodiment where a serving AP seeks to shed a candidate STA, before initiating a shedding request, the AP seeking to shed a candidate STA, e.g., AP 102-1, polls the candidate neighboring AP(s) and shares its intent to shed a candidate STA (STA 104-1), along with the L4S queue the candidate STA (STA 104-1) has on the current AP. The candidate neighboring APs may be some or all of the neighboring APs of AP 102-1. In the example of FIG. 1A , the candidate neighboring APs are APs 102-2 and 102-3. The neighboring AP can either accept or reject the request of the overloaded AP, AP 102-1. The neighboring AP can also respond with an updated L4S queue report.

There may be cases in which the neighboring AP would refuse the request, such as when the neighboring AP is seeing a sharp rise in its own L4S traffic, and the slope of the curve (in the rise of the L4S traffic) suggests that it may also become overloaded in a short period of time. However, if the neighboring AP accepts the shedding request, the neighboring AP informs the overloaded AP of this decision. Thus, in the example of FIG. 1A, AP 102-2 responds to the polling request from AP 102-1, and indicates that it accepts the STA 104-1, with its associated low latency (L4S) traffic.

This polling may be an AP-to-AP exchange that is part of Multi-AP Coordination (IEEE802.11bn) where APs can exchange information among themselves via wireless (OTA) frames. There are some multi-AP coordination frames being defined for APs to exchange information. Alternatively, this polling could be done over the Distribution System (DS) (by wired exchanges via network 106). The method by which the polling and associated responses is performed can be decided by the relevant APs. For example, this may be done by an extension to a MAPC exchange by which APs exchange L4S queue information as well as their intent to shed some STA candidates to a neighboring AP and then basically getting a response whether a neighboring AP is willing to accept those STAs and provide services to the L4S queues of those STAs.

Thus, the polling interaction between the serving AP and its candidate neighboring APs involves a negotiation between APs to push an L4S STA from one AP to another AP, regardless of whether the AP-to-AP communication is OTA or by wire. The serving AP is informing the candidate neighboring APs that their L4S queues are better than that of the serving AP, and it would be best to push a given STA to them. The neighboring AP can accept taking on that STA. As described below, the serving AP can provide credentials and other information about the STA, and then issue a BSS Transition Management (BTM) Request, in accordance with IEEE 802.11v, to the STA indicating that the STA should roam to a particular neighboring AP because the particular neighboring AP has better L4S performance, and also inform the STA that the particular neighboring AP is expecting the STA to roam to it.

The low latency (e.g., L4S) traffic queue could be building up and going down constantly so it is not possible to take an action based on the instantaneous/momentary view of the L4S queue. Rather, the decision to move a STA may be based on a statistical or historical view of the L4S queue. In other words, congestion metrics may be viewed as a trend over a period of time because congestion can change as fast as every second or so. The relevant time interval over which to consider making a decision to shed a STA may be over a five (5) second time interval or multiple one (1) second time intervals, as an example.

### AP Initiation to Shed a Low Latency STA

In the embodiment in which an AP initiates the shedding of a STA with low latency traffic (low latency or L4S STA), the overloaded serving AP, e.g., AP 102-1, issues a transition request frame (e.g., an IEEE 802.11v BSS Transition Management (BTM) Request message/frame) to the candidate STA asking the STA (e.g., STA 104-1) to roam to a neighboring AP, i.e., one of the candidate APs that the AP polled at steps 184-1 and 184-2, e.g., AP 102-2. This is shown at step 186 in FIG. 1A.

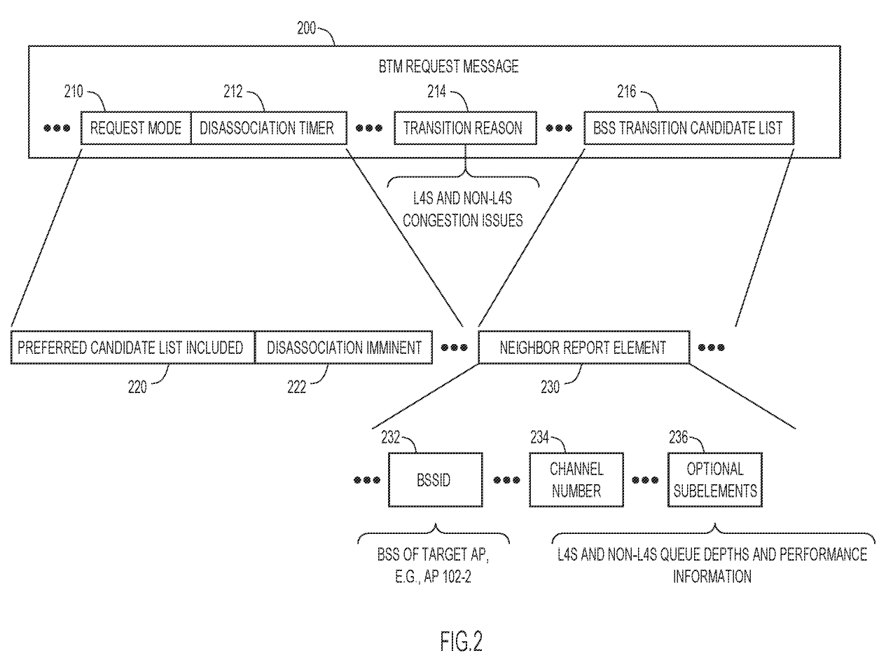

In one embodiment, the BTM Request message is augmented to include a reason code indicating that the roaming request is due to traffic load (e.g., L4S, classic, etc.) congestion issues. An example of a BTM Request message 200 configured for the purposes of shedding a STA for low latency traffic congestion issues is shown in FIG. 2. The BTM Request message 200 includes various fields, only some of which related to the techniques presented herein are shown in FIG. 2. In particular, the BTM Request message includes a Request Mode field 210, a Disassociation Timer field 212, a Transition Reason field 214 and a BSS Transition Candidate List field 216. The Request Mode field 210 includes several subfields, including a Preferred Candidate List Included subfield (bit) 220 and a Disassociation Imminent subfield (bit) 222. The Preferred Candidate List Included (bit) subfield 220 indicates whether the BSS transition candidate list included in this frame is a preferred candidate list or a list of known BSS transition candidates. When the bit of the Preferred Candidate List Included subfield 220 is set to 1, this indicates that the AP expects the receiving STA to process this frame. In the case of the use of the BTM Request message in the operational flow depicted in FIG. 1A, the Preferred Candidate List Included bit would be set to 1. The Disassociation Imminent subfield (bit) 222 indicates whether the STA will be disassociated from the current AP. A value of 1 in the bit of the Disassociation Imminent subfield 22 in the Request indicates that the STA is to be disassociated from the current AP, while a value of 0 indicates that disassociation from the AP is not imminent.

The Disassociation Timer field 212 indicates the time after which the AP issues a Disassociation frame to this STA. The Disassociation Timer field 212 contains the number of target beacon transmission times (TBTTs) until the AP sends a Disassociation frame to this STA. Setting the Disassociation Timer field to 0 indicates that the AP has not determined when it will send a Disassociation frame to this STA.

The Transition Reason field 214 is provided to indicate that the BSS transition is due to traffic load (e.g., L4S, non-L4S, etc.) congestion issues. This field may comprise one or two bits depending on the amount and granularity of information desired.

Depending upon the L4S congestion status (e.g., it is worsening), the current serving AP can set the Disassociation Imminent subfield bit to 1, signaling that the STA will get disassociated soon according to the time indicating in the Disassociation Timer field 212 to more aggressively force the STA to roam to another AP. This is a more explicit/active approach to encouraging a STA to roam to a new AP that has better L4S queue metrics.

The BSS Transition Candidate List field 216 contains zero or more Neighbor Report elements 230. In the context of the use of the BTM Request message in the operations of FIG. 1A , the BSS Transition Candidate List field 216 specifies one neighboring AP (AP 102-2) that the current serving AP, e.g., AP 102-1, has identified and which has accepted the load for the STA to be shed, e.g., STA 104-1. Thus, Neighbor Report Element 230 includes various subfields including a BSSID subfield 232, a Channel Number subfield 234 and an Optional Subelements subfield 236. The BSSID subfield 232 indicates the BSSID of the neighbor AP to which the STA is to roam (the target AP, e.g., AP 102-2). The Channel Number subfield 234 indicates the last known primary channel of the AP indicated by the BSSID specified in the BSSID subfield 232. The Optional Subelements subfield 236 may be used to include various other information, such as the L4S and non-L4S queue depths and performance (and its comparison to the queue depth and performance of the current serving AP).

Referring back to FIG. 1A, the STA 104-1 will accept the BTM Request message set at step 186, and at step 188 the STA roams to the new AP, e.g., AP 102-2. As time progresses, each AP continues to share the L4S and non-L4S queue resource and performance metrics with their neighboring APs such that queue performance may be smoothed across groups of APs.

### STA Initiation to Move to Another AP

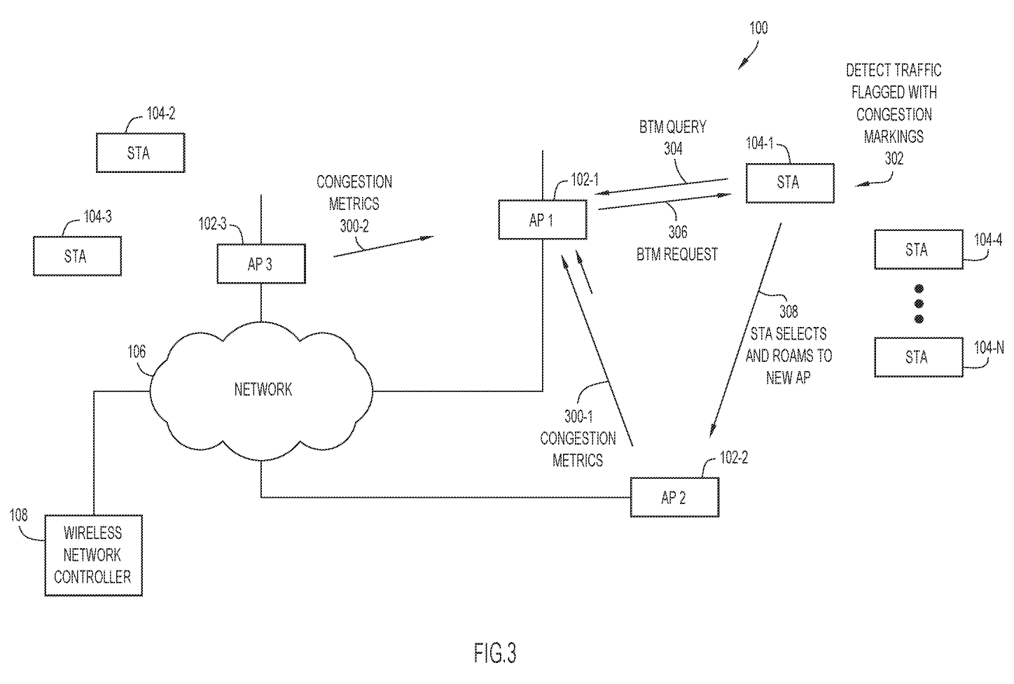

Reference is now made to FIG. 3. FIG. 3 is similar to FIG. 1A as far as how APs share congestion metrics, as shown at steps 300-1 and 300-2, which is similar to steps 180-1 and 180-2 shown in FIG. 1A. However, as mentioned above, in this embodiment, the serving AP, e.g., AP 102-1, does not send a BTM Request to the STA 104-1. Rather, the STA 104-1 measures an increase of traffic flagged with congestion/ECN (markings) and the STA 104-1 by its own initiative decides to look for a better alternative AP to serve its low latency traffic. For example, at step 302, the STA 104-1 receives low latency traffic with ECN markings indicating congestion, or otherwise receives congestion feedback from a server at Layer 4.

The STA 104-1 may proactively seek to determine whether the congestion occurs over the air link, and if a neighboring AP may offer better L4S performance. Thus, instead of the AP identifying candidate STAs to shed and initiating a BTM Request to the candidate STAs as shown in FIG. 1A, the STA 104-1, at 304, sends to the AP 102-1 an L4S-centric BTM Query message in which the STA 104-1 requests from the AP 102-1 information on the best neighboring AP for handling its L4S traffic. In so doing, the STA is looking for another nearby AP that can better serve its L4S flows.

The AP 102-1 responds to the BTM Query message 304 with a BTM Request message 306. The BTM Request message 306 includes information indicating the one or more best candidate neighboring AP(s), identified by the AP 102-1 based on congestion metrics it has been obtaining from its neighboring APs. The BTM Request message 306 includes information about neighboring APs and their L4S and non-L4S queue performance metrics, but can also include L4S and non-L4S queue performance information for the serving AP over a most recent predetermined time interval, and over a previous predetermined time interval, for example.

The STA 104-1 uses that information to determine if the L4S performance has degraded on the serving AP (and thus if the ECN increase is caused by the air interface or there are other causes in the distributed system (DS)). If the STA 104-1 determines that the congestion is due to conditions on the air interface, then at step 308 the STA 104-1 uses the information in the BTM Request message 306 to select and roam to the next best AP (AP 102-2 in this example) to serve its L4S traffic.

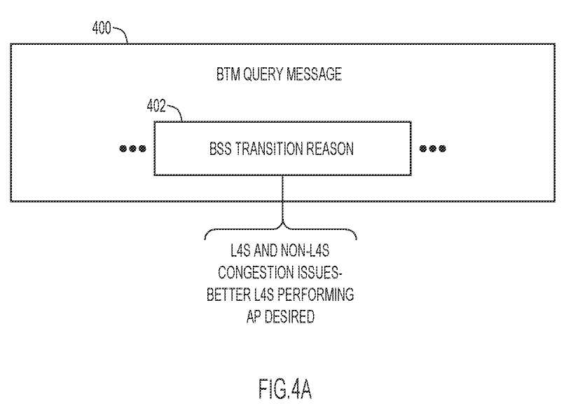

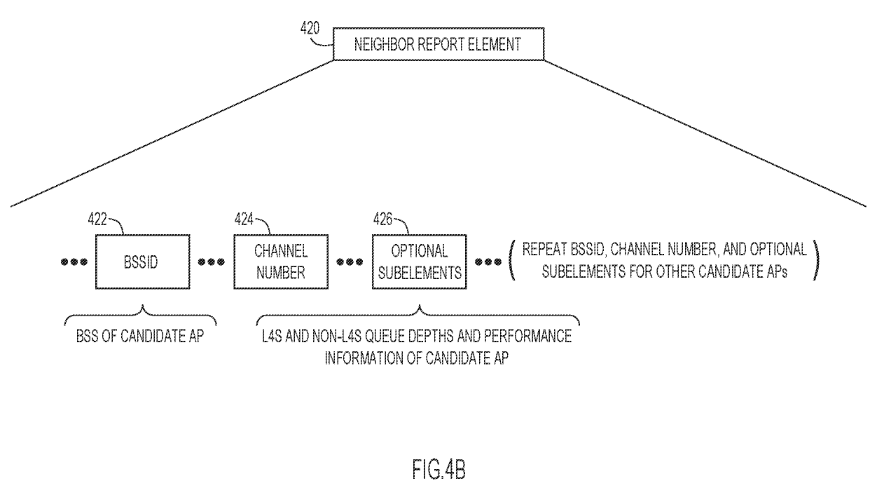

An example of a BTM Query message/frame 400 is shown in FIG. 4A. The BTM Query message 400 comprises various fields, but of relevance to the techniques presented herein the BTM Query message 400 is shown to include a BSS Transition Reason field 402. Using the BTM Query message 400, the STA can request information from its serving AP about neighboring APs that can provide better L4S performance by including an L4S specific Reason Code such as ‘degrading L4S performance at current AP’ or ‘Better L4S performing AP desired’ e.g., in the BSS Transition Reason field 402. As a result, the BTM Query message 400 can be referred to as an “L4S-centric” BTM Query.

FIG. 4B shows an example of the relevant Neighbor Report Element 420 that would be included in the BTM Request message 306 the AP 102-1 sends to the STA 104-1 in response to the BTM Query message 304. The Neighbor Report Element 420 includes, for each candidate neighbor AP that the serving AP indicates has better congestion metrics: a BSSID subfield 422 that contains the BSS of the candidate AP, a Channel Number subfield 424 that identities the channel of the candidate AP (BSS), and an Optional Subelements subfield 426 that includes information for L4S and non-L4S queue depth and performance information for the candidate AP.

In summary, these techniques include providing specific reasons codes in a BTM Query to request for neighboring APs that can provide better L4S performance, or providing a reason code in a BTM Request message for a recommendation of a better L4S AP.

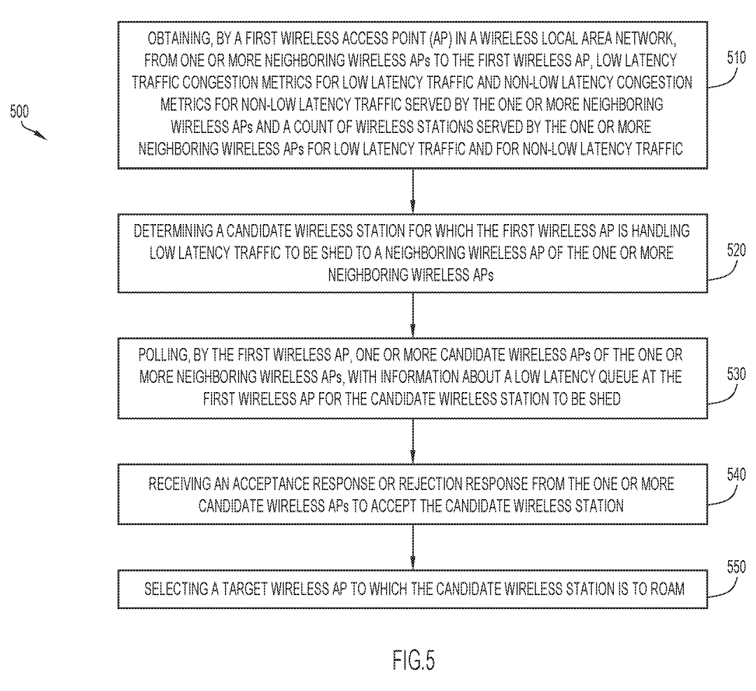

FIG. 5 is a flow chart depicting operations of a method 500 performed by a serving AP in shedding one or more STAs according to the techniques presented herein in connection with FIGS. 1A and 2. The method 500 involves, at step 510, obtaining, by a first wireless access point (AP) in a wireless local area network, from one or more neighboring wireless APs to the first wireless AP, low latency traffic congestion metrics for low latency traffic and non-low latency congestion metrics for non-low latency traffic served by the one or more neighboring wireless APs and a count of wireless stations served by the one or more neighboring wireless APs for low latency traffic and for non-low latency traffic. The low latency traffic may be Low Latency, Low Loss, Scalable Throughput (L4S) traffic that includes packets having information in a header indicating that the packets are carrying L4S traffic based on marking of the packets.

At step 520, the method 500 involves determining a candidate wireless station for which the first wireless AP is handling low latency traffic to be shed to a neighboring wireless AP of the one or more neighboring wireless APs. As explained above, the determining at step 520 may involve identifying the candidate wireless station based on its proximity to a neighboring wireless AP, of the one or more neighboring wireless APs, which has better low latency traffic congestion metrics than that of the first wireless AP.

At step 530, the method 500 involves polling, by the first wireless AP, one or more candidate wireless APs of the one or more neighboring wireless APs, with information about a low latency queue at the first wireless AP for the candidate wireless station to be shed (i.e., forced/suggested/encouraged to roam/transition to another wireless AP). Polling step 530 may involve performing wireless multi-AP coordination (MAPC) WLAN communications or wired network communications between the first wireless AP and the one or more candidate wireless APs.

At step 540, the method 500 involves receiving an acceptance response or rejection response from the one or more candidate wireless APs to accept the candidate wireless station.

At step 550, the method 500 involves selecting a target wireless AP to which the candidate wireless station is to roam.

The method 500 may further involve sending to the candidate wireless station, by the first wireless AP, an IEEE 802.11v Basic Service Set (BSS) Transition Management (BTM) request message indicating that the candidate wireless station is to roam from the first wireless AP to the target wireless AP. The BTM request message may include a reason code field indicating that the roaming request is due to low latency traffic congestion issues. The BTM request message may include, in a neighbor report element, information indicating a low latency queue depth and/or a non-low latency queue depth of the target wireless AP and/or information indicating a comparison of queue depths at the first wireless AP with queue depths at the target wireless AP.

The method 500 may further involve, upon determining, by the first wireless AP, that low latency traffic congestion conditions are worsening at the first wireless AP, sending in the BTM request message a disassociation imminent bit to signal that the candidate wireless station will be disassociated from the first wireless AP upon expiration of a timer of a predetermined duration.

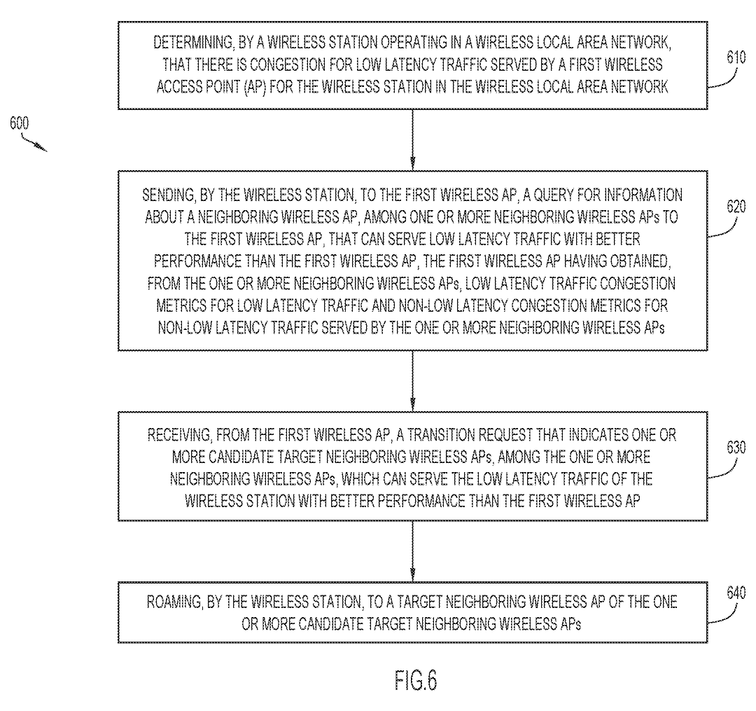

FIG. 6 is a flow chart depicting operations of a method 600 performed by a STA in determining to roam to a neighboring AP according to the techniques presented herein in connection with FIGS. 3, 4A and 4B. The method 600 involves, at step 610, determining, by a wireless station operating in a wireless local area network, that there is congestion for low latency traffic served by a first wireless access point (AP) for the wireless station in the wireless local area network. The low latency traffic may be Low Latency, Low Loss, Scalable Throughput (L4S) traffic that includes packets having information in a header indicating that the packets are carrying L4S traffic based on marking of the packets.

The determining step 610 may involve the wireless station determining an increase of traffic flagged with Explicit Congestion Notification (ECN) markings in traffic received by the wireless station, or receiving congestion feedback from a server at Layer 4 that is a source of the traffic received by the wireless station.

At step 620, the method 600 involves sending, by the wireless station, to the first wireless AP, a query for information about a neighboring wireless AP, among one or more neighboring wireless APs to the first wireless AP, that can serve low latency traffic with better performance than the first wireless AP, the first wireless AP having obtained, from the one or more neighboring wireless APs, low latency traffic congestion metrics for low latency traffic and non-low latency congestion metrics for non-low latency traffic served by the one or more neighboring wireless APs.

In one form, the query is an IEEE 802.11v Basic Service Set (BSS) Transition Management (BTM) Query frame that includes a query reason field containing information indicating that a query reason is degraded low latency traffic performing at the first wireless AP and that the wireless station is seeking to roam to a neighboring wireless AP, of the one or more neighboring wireless APs, that can provide better low latency traffic performance than the first wireless AP.

At step 630, the method 600 involves receiving, from the first wireless AP, a transition request that indicates one or more candidate target neighboring wireless APs, among the one or more neighboring wireless APs, which can serve the low latency traffic of the wireless station with better performance than the first wireless AP. In one form, the transition request is a BTM Request frame that includes information in a neighbor report element that identifies the one or more candidate target neighboring wireless APs and information indicating low latency traffic congestion metrics for low latency traffic and non-low latency congestion metrics for non-low latency traffic served by the one or more neighboring wireless APs.

At step 640, the method 600 involves roaming, by the wireless station, to a target neighboring wireless AP of the one or more candidate target neighboring wireless APs.

The method 600 may further involve steps of analyzing the low latency traffic congestion metrics for low latency traffic and non-low latency congestion metrics for non-low latency traffic served by the one or more neighboring wireless APs, and selecting the target neighboring wireless AP of the one or more candidate target neighboring wireless APs based on the analyzing.

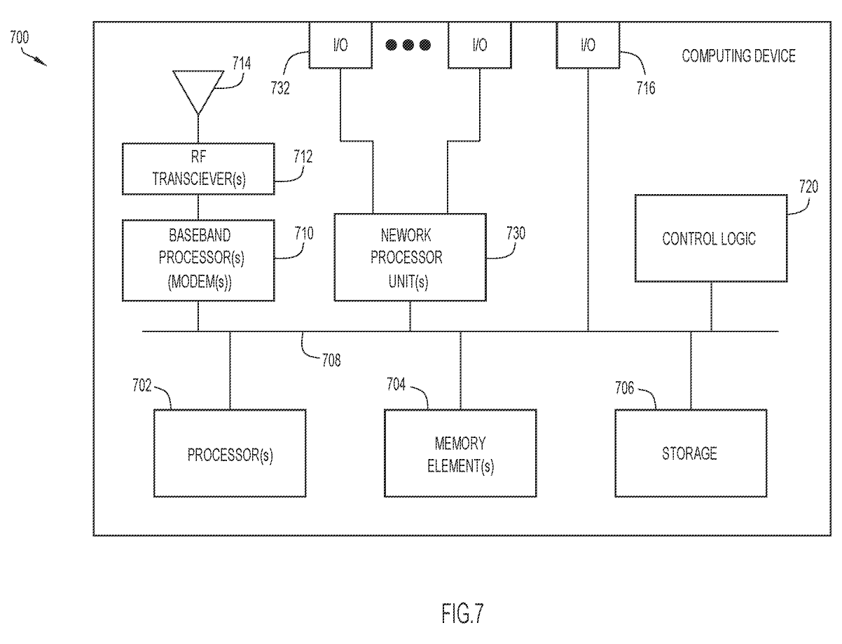

Referring to FIG. 7, FIG. 7 illustrates a hardware block diagram of a computing device 700 that may perform functions associated with operations discussed herein in connection with the techniques described for embodiments herein. In various embodiments, a computing device or apparatus, such as computing device 700 or any combination of computing devices 700, may be configured as any entity/entities in order to perform operations of the various techniques discussed for embodiments herein, such as any elements, functions, etc. discussed for embodiments herein (e.g., an AP, a STA, a wireless network controller, etc.).

In at least one embodiment, the computing device 700 may be any apparatus that may include one or more processor(s) 702, one or more memory element(s) 704, storage 706, a bus 708, one or more network processor unit(s) 730 interconnected with one or more network input/output (I/O) interface(s) 732, one or more I/O interface(s) 716, and control logic 720. In various embodiments, instructions associated with logic for computing device 700 can overlap in any manner and are not limited to the specific allocation of instructions and/or operations described herein.

Computing device 700 may further include at least one baseband processor or modem 710, one or more radio RF transceiver(s) 712 (e.g., any combination of RF receiver(s) and RF transmitter(s)), one or more antenna(s) or antenna array(s) 714 (which may be inclusive of software-defined antenna(s) or antenna array(s)) in accordance with embodiments herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa) or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 730 may enable communication between computing device 700 and other systems, entities, etc., via network I/O interface(s) 732 (wired and/or wireless) to facilitate operations discussed for various embodiments described herein. In various embodiments, network processor unit(s) 730 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 732 can be configured as one or more Ethernet port(s), Fibre Channel ports, any other I/O port(s), and/or antenna(s)/antenna array(s) now known or hereafter developed. Thus, the network processor unit(s) 730 and/or network I/O interface(s) 732 may include suitable interfaces for receiving, transmitting, and/or otherwise communicating data and/or information (wired and/or wirelessly) in a network environment.

I/O interface(s) 716 allow for input and output of data and/or information with other entities that may be connected to computing device 700. For example, I/O interface(s) 716 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 712 may perform RF transmission and RF reception of wireless signals via antenna(s)/antenna array(s) 714, and the baseband processor or modem 710 performs baseband modulation and demodulation, etc. associated with such signals to enable wireless communications for computing device 700.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method including: obtaining, by a first wireless access point (AP) in a wireless local area network, from one or more neighboring wireless APs to the first wireless AP, low latency traffic congestion metrics for low latency traffic and non-low latency congestion metrics for non-low latency traffic served by the one or more neighboring wireless APs and a count of wireless stations served by the one or more neighboring wireless APs for low latency traffic and for non-low latency traffic, wherein the low latency traffic is Low Latency, Low Loss, Scalable Throughput (L4S) traffic that includes packets having information in a header indicating that the packets are carrying L4S traffic based on marking of the packets; determining a candidate wireless station for which the first wireless AP is handling low latency traffic to be shed to a neighboring wireless AP of the one or more neighboring wireless APs; polling, by the first wireless AP, one or more candidate wireless APs of the one or more neighboring wireless APs, with information about a low latency queue at the first wireless AP for the candidate wireless station to be shed; receiving an acceptance response or rejection response from the one or more candidate wireless APs to accept the candidate wireless station; and selecting a target wireless AP to which the candidate wireless station is to roam.

In some aspects, the techniques described herein relate to a method, wherein determining includes identifying the candidate wireless station based on its proximity to a neighboring wireless AP, of the one or more neighboring wireless APs, which has better low latency traffic congestion metrics than that of the first wireless AP.

In some aspects, the techniques described herein relate to a method, wherein polling includes performing wireless multi-AP coordination (MAPC) WLAN communications or wired network communications between the first wireless AP and the one or more candidate wireless APs.

In some aspects, the techniques described herein relate to a method, further including: sending to the candidate wireless station, by the first wireless AP, an IEEE 802.11v Basic Service Set (BSS) Transition Management (BTM) request message indicating that the candidate wireless station is to roam from the first wireless AP to the target wireless AP.

In some aspects, the techniques described herein relate to a method, wherein the BTM request message includes a reason code field indicating that the roaming request is due to low latency traffic congestion issues.

In some aspects, the techniques described herein relate to a method, wherein the BTM request message includes, in a neighbor report element, information indicating a low latency queue depth and/or a non-low latency queue depth of the target wireless AP and/or information indicating a comparison of queue depths at the first wireless AP with queue depths at the target wireless AP.

In some aspects, the techniques described herein relate to a method, further including: upon determining, by the first wireless AP, that low latency traffic congestion conditions are worsening at the first wireless AP, sending in the BTM request message a disassociation imminent bit to signal that the candidate wireless station will be disassociated from the first wireless AP upon expiration of a timer of a predetermined duration.

In some aspects, the techniques described herein relate to a method including: determining, by a wireless station operating in a wireless local area network, that there is congestion for low latency traffic served by a first wireless access point (AP) for the wireless station in the wireless local area network, wherein the low latency traffic is Low Latency, Low Loss, Scalable Throughput (L4S) traffic that includes packets having information in a header indicating that the packets are carrying L4S traffic based on marking of the packets; sending, by the wireless station, to the first wireless AP, a query for information about a neighboring wireless AP, among one or more neighboring wireless APs to the first wireless AP, that can serve low latency traffic with better performance than the first wireless AP, the first wireless AP having obtained, from the one or more neighboring wireless APs, low latency traffic congestion metrics for low latency traffic and non-low latency congestion metrics for non-low latency traffic served by the one or more neighboring wireless APs; receiving, from the first wireless AP, a transition request that indicates one or more candidate target neighboring wireless APs, among the one or more neighboring wireless APs, which can serve the low latency traffic of the wireless station with better performance than the first wireless AP; and roaming, by the wireless station, to a target neighboring wireless AP of the one or more candidate target neighboring wireless APs.

In some aspects, the techniques described herein relate to a method, wherein the query is an IEEE 802.11v Basic Service Set (BSS) Transition Management (BTM) Query frame that includes a query reason field containing information indicating that a query reason is degraded low latency traffic performing at the first wireless AP and that the wireless station is seeking to roam to a neighboring wireless AP, of the one or more neighboring wireless APs, that can provide better low latency traffic performance than the first wireless AP.

In some aspects, the techniques described herein relate to a method, wherein the transition request is a BTM Request frame that includes information in a neighbor report element that identifies the one or more candidate target neighboring wireless APs and information indicating low latency traffic congestion metrics for low latency traffic and non-low latency congestion metrics for non-low latency traffic served by the one or more neighboring wireless APs.

In some aspects, the techniques described herein relate to a method, further including: analyzing the low latency traffic congestion metrics for low latency traffic and non-low latency congestion metrics for non-low latency traffic served by the one or more neighboring wireless APs; and selecting the target neighboring wireless AP of the one or more candidate target neighboring wireless APs based on the analyzing.

In some aspects, the techniques described herein relate to a method, wherein determining includes the wireless station determining an increase of traffic flagged with Explicit Congestion Notification (ECN) markings in traffic received by the wireless station, or receiving congestion feedback from a server at Layer 4 that is a source of the traffic received by the wireless station.

In some aspects, the techniques described herein relate to an apparatus including: a wireless network interface configured to enable wireless communications in a wireless area network (WLAN) on behalf of a first wireless access point (AP) to serve one or more wireless stations; and at least one processor coupled to the wireless network interface, the at least one processor configured to perform operations including: obtaining from one or more neighboring wireless APs to the first wireless AP, low latency traffic congestion metrics for low latency traffic and non-low latency congestion metrics for non-low latency traffic served by the one or more neighboring wireless APs and a count of wireless stations served by the one or more neighboring wireless APs for low latency traffic and for non-low latency traffic; determining a candidate wireless station for which the first wireless AP is handling low latency traffic to be shed to a neighboring wireless AP of the one or more neighboring wireless APs; poll one or more candidate wireless APs of the one or more neighboring wireless APs, with information about a low latency queue at the first wireless AP for the candidate wireless station to be shed; receiving an acceptance response or rejection response from the one or more candidate wireless APs to accept the candidate wireless station; and selecting a target wireless AP to which the candidate wireless station is to roam.

In some aspects, the techniques described herein relate to an apparatus, wherein determining includes identifying the candidate wireless station based on its proximity to a neighboring wireless AP, of the one or more neighboring wireless APs, which has better low latency traffic congestion metrics than that of the first wireless AP.

In some aspects, the techniques described herein relate to an apparatus, wherein polling includes performing wireless multi-AP coordination (MAPC) WLAN communications or wired network communications between the first wireless AP and the one or more candidate wireless APs.

In some aspects, the techniques described herein relate to an apparatus, wherein the at least one processor is further configured to perform operations including: causing the wireless network interface to send to the candidate wireless station an IEEE 802.11v Basic Service Set (BSS) Transition Management (BTM) request message indicating that the candidate wireless station is to roam from the first wireless AP to the target wireless AP.

In some aspects, the techniques described herein relate to an apparatus, wherein the BTM request message includes a reason code field indicating that the roaming request is due to low latency traffic congestion issues.

In some aspects, the techniques described herein relate to an apparatus, wherein the BTM request message includes, in a neighbor report element, information indicating a low latency queue depth and/or a non-low latency queue depth of the target wireless AP and/or information indicating a comparison of queue depths at the first wireless AP with queue depths at the target wireless AP.

In some aspects, the techniques described herein relate to an apparatus, wherein the at least one processor is further configured to perform operations including: upon determining, by the first wireless AP, that low latency traffic congestion conditions are worsening at the first wireless AP, sending in the BTM request message a disassociation imminent bit to signal that the candidate wireless station will be disassociated from the first wireless AP upon expiration of a timer of a predetermined duration.

In some aspects, the techniques described herein relate to an apparatus, wherein the low latency traffic is Low Latency, Low Loss, Scalable Throughput (L4S) traffic that includes packets having information in a header indicating that the packets are carrying L4S traffic based on marking of the packets.

In some aspects, an apparatus is provided that includes a wireless network interface configured to enable wireless communications in a wireless area network (WLAN) on behalf of a wireless station that is served by a first wireless access point (AP) in a wireless local area network; and at least one processor configured to perform operations including: determining that there is congestion for low latency traffic served by the first wireless AP for the wireless station in the wireless local area network, wherein the low latency traffic is Low Latency, Low Loss, Scalable Throughput (L4S) traffic that includes packets having information in a header indicating that the packets are carrying L4S traffic based on marking of the packets; cause the wireless network interface to send to the first wireless AP, a query for information about a neighboring wireless AP, among one or more neighboring wireless APs to the first wireless AP, that can serve low latency traffic with better performance than the first wireless AP, the first wireless AP having obtained, from the one or more neighboring wireless APs, low latency traffic congestion metrics for low latency traffic and non-low latency congestion metrics for non-low latency traffic served by the one or more neighboring wireless APs; causing the wireless network interface to receive, from the first wireless AP, a transition request that indicates one or more candidate target neighboring wireless APs, among the one or more neighboring wireless APs, which can serve the low latency traffic of the wireless station with better performance than the first wireless AP; and causing the wireless station to roam to a target neighboring wireless AP of the one or more candidate target neighboring wireless APs.

In one form, one or more computer readable storage media encoded with software comprising computer executable instructions is/are provided herein that, when the software, is/are executed operable to perform operations as shown and described herein.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by a first wireless access point (AP) in a wireless local area network, from one or more neighboring wireless APs to the first wireless AP, low latency traffic congestion metrics for low latency traffic and non-low latency congestion metrics for non-low latency traffic served by the one or more neighboring wireless APs and a count of wireless stations served by the one or more neighboring wireless APs for low latency traffic and for non-low latency traffic, wherein the low latency traffic is Low Latency, Low Loss, Scalable Throughput (L4S) traffic that includes packets having information in a header indicating that the packets are carrying L4S traffic based on marking of the packets;
determining a candidate wireless station for which the first wireless AP is handling low latency traffic to be shed to a neighboring wireless AP of the one or more neighboring wireless APs;
polling, by the first wireless AP, one or more candidate wireless APs of the one or more neighboring wireless APs, with information about a low latency queue at the first wireless AP for the candidate wireless station to be shed;
receiving an acceptance response or rejection response from the one or more candidate wireless APs to accept the candidate wireless station; and
selecting a target wireless AP to which the candidate wireless station is to roam.

2. The method of claim 1, wherein determining comprises identifying the candidate wireless station based on its proximity to a neighboring wireless AP, of the one or more neighboring wireless APs, which has better low latency traffic congestion metrics than that of the first wireless AP.

3. The method of claim 1, wherein polling comprises performing wireless multi-AP coordination (MAPC) WLAN communications or wired network communications between the first wireless AP and the one or more candidate wireless APs.

4. The method of claim 1, further comprising:
sending to the candidate wireless station, by the first wireless AP, an IEEE 802.11v Basic Service Set (BSS) Transition Management (BTM) request message indicating that the candidate wireless station is to roam from the first wireless AP to the target wireless AP.

5. The method of claim 4, wherein the BTM request message comprises a reason code field indicating that the roaming request is due to low latency traffic congestion issues.

6. The method of claim 4, wherein the BTM request message includes, in a neighbor report element, information indicating a low latency queue depth and/or a non-low latency queue depth of the target wireless AP and/or information indicating a comparison of queue depths at the first wireless AP with queue depths at the target wireless AP.

7. The method of claim 4, further comprising:
upon determining, by the first wireless AP, that low latency traffic congestion conditions are worsening at the first wireless AP, sending in the BTM request message a disassociation imminent bit to signal that the candidate wireless station will be disassociated from the first wireless AP upon expiration of a timer of a predetermined duration.

8. A method comprising:
determining, by a wireless station operating in a wireless local area network, that there is congestion for low latency traffic served by a first wireless access point (AP) for the wireless station in the wireless local area network, wherein the low latency traffic is Low Latency, Low Loss, Scalable Throughput (L4S) traffic that includes packets having information in a header indicating that the packets are carrying L4S traffic based on marking of the packets;
sending, by the wireless station, to the first wireless AP, a query for information about a neighboring wireless AP, among one or more neighboring wireless APs to the first wireless AP, that can serve low latency traffic with better performance than the first wireless AP, the first wireless AP having obtained, from the one or more neighboring wireless APs, low latency traffic congestion metrics for low latency traffic and non-low latency congestion metrics for non-low latency traffic served by the one or more neighboring wireless APs;
receiving, from the first wireless AP, a transition request that indicates one or more candidate target neighboring wireless APs, among the one or more neighboring wireless APs, which can serve the low latency traffic of the wireless station with better performance than the first wireless AP; and
roaming, by the wireless station, to a target neighboring wireless AP of the one or more candidate target neighboring wireless APs.

9. The method of claim 8, wherein the query is an IEEE 802.11v Basic Service Set (BSS) Transition Management (BTM) Query frame that includes a query reason field containing information indicating that a query reason is degraded low latency traffic performing at the first wireless AP and that the wireless station is seeking to roam to a neighboring wireless AP, of the one or more neighboring wireless APs, that can provide better low latency traffic performance than the first wireless AP.

10. The method of claim 9, wherein the transition request is a BTM Request frame that includes information in a neighbor report element that identifies the one or more candidate target neighboring wireless APs and information indicating low latency traffic congestion metrics for low latency traffic and non-low latency congestion metrics for non-low latency traffic served by the one or more neighboring wireless APs.

11. The method of claim 8, further comprising:
analyzing the low latency traffic congestion metrics for low latency traffic and non-low latency congestion metrics for non-low latency traffic served by the one or more neighboring wireless APs; and
selecting the target neighboring wireless AP of the one or more candidate target neighboring wireless APs based on the analyzing.

12. The method of claim 8, wherein determining comprises the wireless station determining an increase of traffic flagged with Explicit Congestion Notification (ECN) markings in traffic received by the wireless station, or receiving congestion feedback from a server at Layer 4 that is a source of the traffic received by the wireless station.

13. An apparatus comprising:
a wireless network interface configured to enable wireless communications in a wireless area network (WLAN) on behalf of a first wireless access point (AP) to serve one or more wireless stations; and
at least one processor coupled to the wireless network interface, the at least one processor configured to perform operations including:
obtaining from one or more neighboring wireless APs to the first wireless AP, low latency traffic congestion metrics for low latency traffic and non-low latency congestion metrics for non-low latency traffic served by the one or more neighboring wireless APs and a count of wireless stations served by the one or more neighboring wireless APs for low latency traffic and for non-low latency traffic;
determining a candidate wireless station for which the first wireless AP is handling low latency traffic to be shed to a neighboring wireless AP of the one or more neighboring wireless APs;
poll one or more candidate wireless APs of the one or more neighboring wireless APs, with information about a low latency queue at the first wireless AP for the candidate wireless station to be shed;
receiving an acceptance response or rejection response from the one or more candidate wireless APs to accept the candidate wireless station; and
selecting a target wireless AP to which the candidate wireless station is to roam.

14. The apparatus of claim 13, wherein determining comprises identifying the candidate wireless station based on its proximity to a neighboring wireless AP, of the one or more neighboring wireless APs, which has better low latency traffic congestion metrics than that of the first wireless AP.

15. The apparatus of claim 13, wherein polling comprises performing wireless multi-AP coordination (MAPC) WLAN communications or wired network communications between the first wireless AP and the one or more candidate wireless APs.

16. The apparatus of claim 13, wherein the at least one processor is further configured to perform operations including:
causing the wireless network interface to send to the candidate wireless station an IEEE 802.11v Basic Service Set (BSS) Transition Management (BTM) request message indicating that the candidate wireless station is to roam from the first wireless AP to the target wireless AP.

17. The apparatus of claim 16, wherein the BTM request message comprises a reason code field indicating that the roaming request is due to low latency traffic congestion issues.

18. The apparatus of claim 16, wherein the BTM request message includes, in a neighbor report element, information indicating a low latency queue depth and/or a non-low latency queue depth of the target wireless AP and/or information indicating a comparison of queue depths at the first wireless AP with queue depths at the target wireless AP.

19. The apparatus of claim 16, wherein the at least one processor is further configured to perform operations including:
upon determining, by the first wireless AP, that low latency traffic congestion conditions are worsening at the first wireless AP, sending in the BTM request message a disassociation imminent bit to signal that the candidate wireless station will be disassociated from the first wireless AP upon expiration of a timer of a predetermined duration.

20. The apparatus of claim 16, wherein the low latency traffic is Low Latency, Low Loss, Scalable Throughput (L4S) traffic that includes packets having information in a header indicating that the packets are carrying L4S traffic based on marking of the packets.
